(19) United States
(12) Patent Application Publication
(10) Pub. No.: US 2017/0371372 A1
(43) Pub. Date: Dec. 28, 2017

(54) User Input Peripheral

(71) Applicant: Microsoft Technology Licensing, LLC, Redmond, WA (US)

(72) Inventors: Malek Mohamad Nafez Chalabi, Seattle, WA (US); Dustin R. Brown, Kirkland, WA (US)

(73) Assignee: Microsoft Technology Licensing, LLC, Redmond, WA (US)

(21) Appl. No.: 15/349,568

(22) Filed: Nov. 11, 2016

Related U.S. Application Data
(60) Provisional application No. 62/361,356, filed on Jul. 12, 2016.
(60) Provisional application No. 62/353,978, filed on Jun. 23, 2016.

(51) Int. Cl. G06F 1/16; H04M 1/11

(52) U.S. Cl. CPC G06F 1/1632; G06F 1/1688; H04M 1/11

(57) ABSTRACT

A peripheral device for use with a user terminal, the peripheral device comprising: a first section; a second section; the first and second sections being arranged relative to each other in a clamshell manner, and the first and second sections being movable relative to each other between a first, closed configuration of the peripheral device, and a second, open configuration of the peripheral device; the peripheral device comprising a flexible tether portion connecting the first section to the second section; the flexible tether portion being biased so as to maintain a tension in the tether.

### RELATED APPLICATIONS

This application claims priority under 35 U.S.C Section 119(e) to U.S. Provisional Patent Application No. 62/353,978, filed Jun. 23, 2016 and titled “User Input Peripheral” and to U.S. Provisional Patent Application No. 62/361,356, filed Jul. 12, 2016 and titled “User Input Peripheral”, the entire disclosures of which are hereby incorporated by reference.

### BACKGROUND

One existing type of peripheral for use with a mobile phone is a docking station which acts as a speaker phone when the phone is docked in the docking station. This may operate in conjunction with the native dialler of the phone (e.g. a cellular dialler) or a separate application such as a VoIP application. Either way, when the phone is docked the audio to be transmitted from the near-end user to the far end-user(s) is captured by a microphone in the docking station instead of the phone's internal microphone, and transferred from that microphone though the docking connection to the phone, then on to the far-end user terminal(s). And/or, the audio received from the far-end user terminal(s) is not played out through the phone's internal speaker, but rather is transferred from the phone to the docking station via the docking connection and played out through a speaker in the docking station. The docking station usually also supplies power to the phone during the call and charges its battery. The user can answer and control the call in the normal way by navigating through the graphical user interface presented on the display screen of the phone (nowadays typically a touchscreen).

### SUMMARY

It is identified herein that existing peripherals such as user terminal docking stations may not provide a suitably stable base for a user terminal (e.g. mobile phone, tablet) docked thereon. This can make it difficult for a user to operate the user terminal while it is in its docked state, since contact with the user terminal (for example contact on a touchscreen thereof), may cause the user terminal and docking station to move or topple over. Docking stations which do provide a stable base tend to be heavy, bulky items that cannot be easily transported.

It would be desirable to provide a peripheral device which can provide a stable base for a user terminal docked thereon, and which peripheral device is relatively compact for easy transport.

According to one aspect disclosed herein, there is provided a peripheral device for use with a user terminal, the peripheral device comprising: a first section; a second section; the first and second sections being arranged relative to each other in a clamshell manner, and the first and second sections being movable relative to each other between a first, closed configuration of the peripheral device, and a second, open configuration of the peripheral device; the peripheral device comprising a flexible tether portion connecting the first section to the second section; the flexible tether portion being biased so as to maintain a tension in the tether.

Thus there is provided a peripheral device which can open and close in a clamshell manner between fully closed and fully open states. In its fully closed state the peripheral device is compact and can be easily transported, for example in a rucksack, handbag, user's hand etc. Once opened out in to its fully open state the peripheral device provides a stable base for a user terminal (e.g. phone, tablet) that is docked thereon. The biased tether helps to hold the two sections of the clamshell together, whether that is in the closed state or the open state of the peripheral device. Therefore, the retractable connector mechanism, in the form of the biased flexible tether, ensures that both sections of the device can assume a closed stack configuration, as well as an open flat configuration. Where the first and second sections have generally circular or circular outer peripheries then both sections can touch each other in a tangential manner when the device is in an open configuration. In some embodiments the mechanism is facilitated by magnets on the first and second sections (and optionally cavities and/or undercuts on the two sections) to ensure that the retractable tether mechanism can interlock both sections of the peripheral device in the fully open and fully closed configurations listed above.

In some embodiments, the flexible tether is biased by a biasing arrangement located in one or both of the first section and the second section.

In some embodiments, the biasing arrangement comprises a clamping arrangement which clamps the tether.

In some embodiments, the clamping arrangement comprises first and second plates which clamp the tether therebetween.

In some embodiments, the clamping arrangement is configured to translate back and forth in response to the peripheral device being moved between its first and second configurations.

In some embodiments, the clamping arrangement has a first position when the peripheral device is in its first, closed configuration, and the clamping arrangement has a second position when the peripheral device is in its second, open configuration.

In some embodiments, the clamping arrangement is configured to move with a biasing force of the biasing arrangement when the clamping arrangement is moved from the first position to the second position.

In some embodiments, the clamping arrangement is configured to move against a biasing force of the biasing arrangement when the clamping arrangement is moved from the second position to the first position.

In some embodiments, the biasing arrangement is comprised in the first section, and the biasing arrangement is configured to allow the flexible tether to be drawn in a direction in to the first section when the peripheral device is moved from its closed configuration to its open configuration, and wherein the biasing arrangement is configured to allow the flexible tether to be drawn in a direction out of the first section when the peripheral device is moved from its open configuration to its closed configuration.

In some embodiments, the biasing arrangement comprises a helical spring.

In some embodiments, the tether comprises a flat electrical cable, configured for electrically connecting the first and second sections.

In some embodiments, when the peripheral device is in its open configuration the tether assumes a generally straight profile, and when the peripheral device is in its closed configuration at least a portion of the tether assumes a generally U-shaped profile.

In some embodiments, the first and second sections each have a generally circular outer periphery.

In some embodiments, one of the first and second sections has a crescent shaped indentation therein, the crescent shaped indentation configured to receive the generally circular outer periphery of the other of the first and second sections when the peripheral device is in its open configuration.

In some embodiments, the peripheral device comprises at least one magnet arrangement arranged to assist in holding the peripheral device in its closed configuration, and at least one further magnet arrangement arranged to assist in holding the peripheral device in its open configuration.

In some embodiments, an interface projects from one or other of the first and second sections for communicatively connecting to a user terminal.

In some embodiments, the peripheral device comprises a cavity located in the other of the first and second sections, wherein the cavity is configured to receive the interface when the peripheral device is in its closed configuration.

In some embodiments, the interface projects at an angle from a surface of the first or second section, the cavity extending in to the other of the first or second surface at the same angle.

In some embodiments, the interface is connected to the flexible tether for electrical communication therewith.

In some embodiments, the peripheral device comprises control logic for interfacing with the user terminal via said interface, in order to control a communication client application running on the user terminal, and to thereby control a voice or video call that is conducted over a packet-based network from the user terminal using the communication client application.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all of the disadvantages noted herein.

### BRIEF DESCRIPTION OF THE DRAWINGS

To assist understanding of the present disclosure and to show how embodiments may be put in effect, reference is made by way of example to the accompanying drawings in which:

FIG. 1 is a schematic block diagram of a communication system,

FIG. 2 shows an example design of a docking station,

FIG. 3 shows a user terminal docked with a docking station,

FIG. 4 shows a docking station in a partially open configuration;

FIG. 5 is a plan view of a docking station;

FIG. 6 is an isometric view of a docking station in a fully closed configuration;

FIG. 7 is a side, partially sectioned view of a docking station;

FIG. 8 is an isometric, partially sectioned view of a docking station;

FIG. 9 is a plan, partially sectioned view of a docking station;

FIG. 10 is an exploded view showing some components of a docking station;

FIG. 11 is an isometric, partially sectioned view of a docking station;

FIG. 12 is an isometric view of a docking station.

### DETAILED DESCRIPTION OF EMBODIMENTS

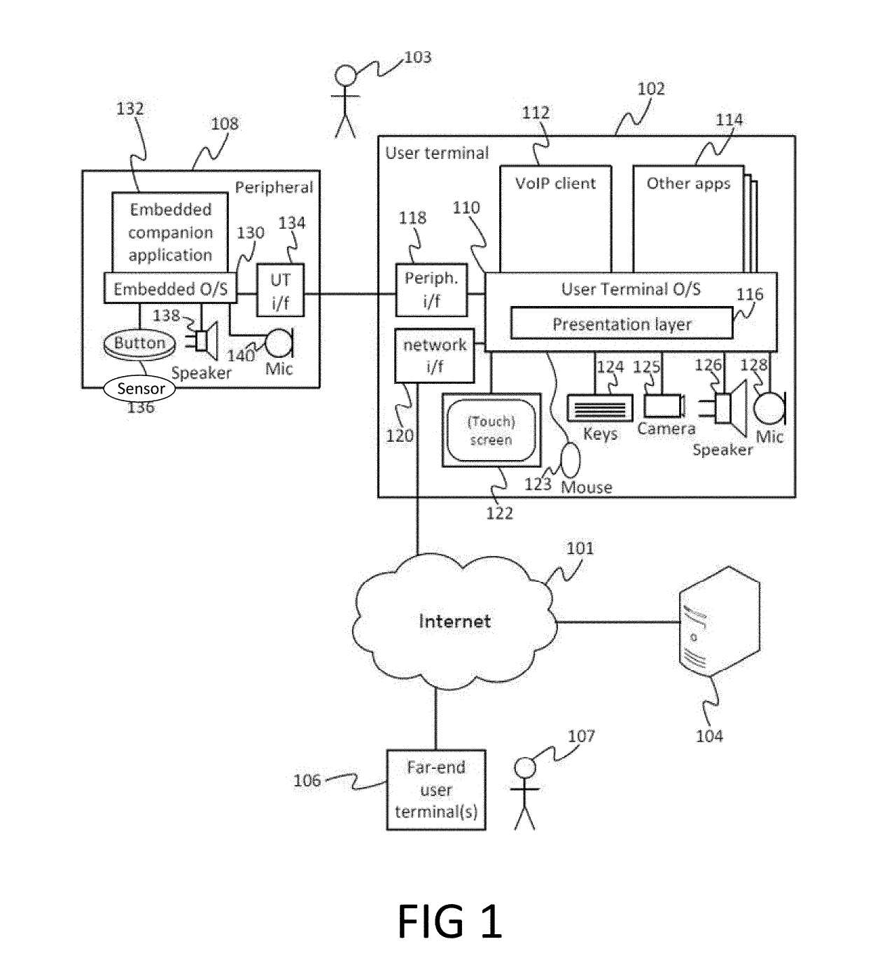

FIG. 1 illustrates an example communication system in accordance with embodiments disclosed herein. The system comprises a user terminal 102 such as a mobile phone, tablet, laptop computer or desktop computer; and a peripheral device 108 configured to connect to the user terminal 102. As will be discussed in more detail later, the peripheral 108 may be a docking station. The peripheral device 108 may also be referred to as a hardware accessory in that, while it may in embodiments run embedded firmware, it is a relatively simple device with a dedicated purpose and only a single or a small number of user input controls (e.g. no more than the buttons) and preferably no screen (though in embodiments it is not excluded that the peripheral 108 could have a small screen for some simple or dedicated purpose).

The user terminal 102 comprises an operating system 110, a communication client application 112, and one or more other applications 114 (e.g. in embodiments over one hundred applications, or “apps”, and even up to hundred to three hundred applications or more). The operating system 110, communication client 112 and other application(s) 114 are stored on a storage means of the user terminal 102 and arranged to be run (either executed or interpreted) on a processor of the user terminal 102, and to thereby perform the various operations attributed to them herein. The storage on which the operating system 110, communication client application 112 and other application(s) 114 are stored may comprise any one or more storage media implemented in one or more memory units. E.g. the storage means may comprise an electronic storage medium such as an EEPROM (or “flash” memory) and/or a magnetic storage medium such as a hard disk. Note also that the term “processor” as used herein does not exclude that the processor may comprise multiple processing units. The communication client application 112 and other application(s) 114 are each separate applications from one another, individual applications at least in that they are scheduled independently by the operating system 110, and/or can be launched, run and closed independently of one another.

The user terminal 102 also comprises one or more input devices for outputting information to the user 103 and one or more output devices for receiving information from the user 103 (which may be referred to collectively as i/o devices). These include one or more media output devices for outputting audio and visual information from the applications 112, 114 to the user 103, i.e. at least one speaker 126 and a screen 122, respectively. The i/o devices also include one or more media input devices for receiving audio and optionally video information from the user 103, i.e. as a microphone 128 and optionally a camera 125. Furthermore, the i/o devices comprise one or more user input devices enabling the applications 112, 114 to receive user selections from the user 103, such as a mouse or trackpad 123, a set of keys 124 (e.g. a keyboard or keypad), and/or a touchscreen 122 (the screen 122 may or may not be a touchscreen capable of both outputting visual information and receiving inputs form the user 103). The operating system 110 running on the user terminal 102 is an end-user operating system, i.e. designed for user terminals to provide an interface to the end user 103, to present information from applications 112, 114 to a user 103 through a graphical user interface presented on a screen 122, and to receive back inputs to the applications 112, 114 from the user 103 through one or more user input devices 122, 123, 124, 125, 128. As such the user operating system 110 comprises a presentation layer 116. The presentation layer 116 is the layer disposed between the application layer 112, 114 and lower layers (not shown), which formats data from the lower layers to be presented to the application layer 112, 114, and formats data from the application layer 112, 114 to be presented to the lower layers. This includes responsibility for painting graphical user interface on the screen, and receiving inputs from the user selections from the user input devices 122, 124 in relation to the graphical user interface.

Note that each of the i/o devices 122, 123, 124, 125, 126, 128 may be internal or external to the main housing in which the processor running the applications 112, 114 is housed, e.g. as follows. In embodiments the screen 122 may be an integral screen of a smartphone, tablet or laptop or an external screen of a desktop computer. The set of keys 124 may be an integral key set of a smartphone or tablet, an integral keyboard of a laptop or an external keyboard of a desktop computer. The (at least one) speaker 126 may be an internal or external speaker of a smartphone, tablet or laptop, or an external speaker of a desktop computer. The microphone 128 may be an internal or external microphone or a smartphone, tablet or laptop, or an external microphone of a desktop computer. And/or, the camera 125 may be an internal camera of a smartphone, tablet or laptop, or an external camera connected to a laptop or desktop computer. If used, a mouse 123 is an external device, but this could instead be an integral trackpad or tracker ball of, say, a laptop computer.

The user terminal 102 further comprises a network interface 120 and a peripheral interface 118.

The network interface 120 enables the user terminal 102 to connect to a packet-based network 101 comprising one or more constituent networks. E.g. in embodiments the network 101 may comprises a wide area internetwork such as that commonly referred to as the Internet. Alternatively or additionally, the network 101 may comprise a wireless local area network (WLAN), a wired or wireless private intranet (such as within a company or an academic or state institution), and/or the data channel of a mobile cellular network. To connect to such a network, the network interface 120 may comprise any of a variety of possible wired or wireless means as will be familiar to a person skilled in the art. For example, if the network 101 comprises the Internet, the network interface 120 may comprise a wired modem configured to connect to the Internet via a wired connection such as a PSTN phone socket or cable or fibre line, or via an Ethernet connection and a local wired network. Or alternatively the network interface 120 may comprise a wireless interface for connecting to the Internet via a wireless access point or wireless router and a local (short-range) wireless access technology such as Wi-Fi), or a mobile cellular interface for connecting to the Internet via a mobile cellular network.

The connection to the network 101 via the network interface 120 allows applications 112, 114 running on the user terminal 102 to conduct communications over the network. This includes enabling the communication client application 112 to conduct a voice or video call with another instance of the client application running on a remote user terminal 106, being used by a remote user 107. As a matter of terminology the user terminal 102 from the perspective of which a given communication scenario is being described may be referred to as the near-end terminal, whilst the other, remote user terminal 106 with which the near-end terminal 102 is communicating may be referred to as the far-end terminal (and similarly for the near-end user 103 and far-end user 107 respectively). Not also that the call could in fact be a conference call conducted with multiple remote user terminals and their respective users. By way of illustration the following will be described in terms of a given remote-user terminal 106, but it will be appreciated that the same teachings can be readily extended to multiple remote user terminals in a similar manner.

The communication client 112 on the near-end user terminal 102 is configured so as, when run on the near-end user terminal 102, to receive audio data from the microphone 128 and optionally also video data from the camera 125 and to send this data over the network 101, via the network interface 120, to be played out at the far-end terminal as part of a call conducted between the near-end user 103 and far-end user 107. Further, the communication client 112 is configured so as when run on the user terminal 102 to receive via the network interface audio and optionally video data from the client on the far-end terminal 106 to be played out through the speaker 126 and screen 122, respectively, on the near-end terminal 102.

In embodiments the communication client 112 is a VoIP client configured to conduct the call in the form of a VoIP call (which may also comprise a video element). The VoIP client may optionally also provide additional functionality such as instant messaging (IM). In some embodiments the audio and/or video content of the call may be routed via a server 104 of a provider of a communication service used to conduct the call (where a server as referred to herein may comprise one or more physical server units at one or more geographical sites). Alternatively, some or all of the audio and/or video content of the call may be sent directly over the network 101 between the near-end and far-end user terminals 102, 106, i.e. without being relayed by the server 104. In the latter case the server 104 may nonetheless provide some supporting functions such as: to provide address look up (or this could be done in a P2P fashion); to issue digital authentication certificates by which users 103 107 may prove their identities to one another; to store respective contact lists of the users 103 107, being a list of other users the respective user has agreed to accept as contacts for communicating with within the communication service; to store profile information of each user which is viewable by other users within the communication service; and/or to maintain presence information indicating to other users whether the respective user's availability to be communicated with within the communication service.

In embodiments, the communication client application (e.g. VoIP application) 112 may be an application other than the native dialler of the operating system 110, i.e. the default dialler user for telephone calls, which is either one of the other applications 114 or an integrated function of the operating system 110 itself

An example implementation of the peripheral device 108 is illustrated in FIG. 1. As shown, the user terminal 102 comprises a peripheral interface 118, and the peripheral device 108 comprises a user terminal interface 134 for connecting the peripheral 108 to the peripheral interface 118 of the user terminal, thus enabling the peripheral device 108 to control the communication client application 112 running on the user terminal 102. This connection could be any suitable wired or wireless means. For instance, the peripheral interface 118 may comprise a physical port comprising a mechanical connector for forming a wired connection with the user terminal interface 134 on the peripheral device 108 (the user terminal interface 134 on the peripheral 108 comprising the complimentary mechanical connector). E.g. the peripheral interface 118 may comprise a USB port, mini USB port micro USB port, and the user terminal interface 134 may comprise the corresponding USB plug. As another example, the connection may be by any of a variety of wireless means. For instance, the peripheral interface 118 and corresponding user terminal interface 134 may comprise a pair of wireless interfaces arranged to connect together via a local RF technology such as Wi-Fi, Bluetooth, ZigBee or Thread. Note also that in the case where both the peripheral interface 118 and network interface 120 comprise a wireless interface, these may or may not comprise the same physical interface. For example, these may comprise the same physical wireless interface using the same wireless access technology (e.g. Wi-Fi) and simply comprise different logic (e.g. software) for interfacing with the peripheral 108 and network 101 respectively. Alternatively, the peripheral interface 118 and network interface 120 may comprise different physical interfaces arranged to use different wireless access technologies, e.g. the peripheral interface 118 may be a Bluetooth interface whilst the network interface 120 may be a Wi-Fi interface.

The peripheral device 108 comprises control logic in the form of an embedded companion application running on an embedded operating system 130 on the peripheral, to act as a companion to the communication client application 112. The embedded operating system 130 and companion application 132 are stored on a storage means of the peripheral device 108 and arranged to be run (either executed or interpreted) on a processor of the user peripheral device 108, and to thereby perform the various operations attributed to them herein. The storage on which the embedded operating system 130 and companion application 138 are stored may comprise any one or more storage media implemented in one or more memory units. E.g. the storage means may comprise an electronic storage medium such as an EEPROM (or “flash” memory) and/or a magnetic storage medium such as a hard disk. Also, note again that the term “processor” as used herein does not exclude that the processor may comprise multiple processing units.

As an alternative (or in addition) to the embedded companion application 132, the control logic may be implemented (or partially so) in the form of dedicated hardware circuitry, or configurable or reconfigurable hardware circuitry such as a PGA (programmable gate array) or FPGA (field programmable gate array).

Either way, whether implemented in software, hardware circuitry or a combination of the two, the peripheral 108 may be described as a “hardware accessory” in that it is a simple, low-level peripheral device that cannot be used as a standalone user terminal without being connected as a peripheral to a user terminal 102. For example, in embodiments the operating system on the peripheral 108 does not comprise a user operating system designed to provide a graphical user interface to the user 103, but instead comprises an embedded operating system that does not comprise a presentation layer. Furthermore, preferably the peripheral device 108 does not comprise any display screen.

Preferably the peripheral device comprises very few buttons, e.g. no more than three buttons. In embodiments the sensor 136 is the only user-operable sensor or button on the whole peripheral 108, or in embodiments that use motion or audio actuation, then the peripheral 108 could even comprise no buttons.

In some embodiments the peripheral 108 may additionally be configured to provide the function of a speaker phone, comprising at least one integrated speaker 138 and/or at least one integrated microphone 140. Thus the peripheral may be configured such that, when connected to the user terminal 102, then one or both of: (a) the received audio of the call from the far-end user 107 can be played out through the speaker 138 of the peripheral 108 instead of the speaker 126 of the user terminal 102, and/or the audio of the call captured from the near-end user 103 to be transmitted to be played out to the far-end user 107 is captured through the microphone 140 on the peripheral 108 instead of the microphone 128 of the user terminal 102.

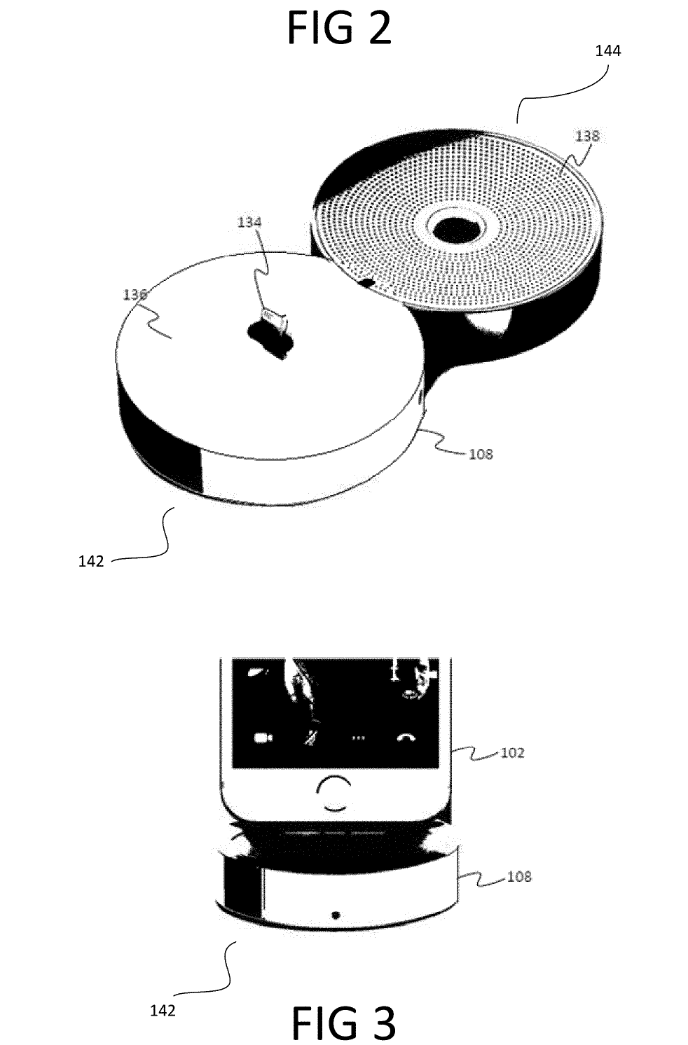

As will now be exemplified with reference to FIGS. 2 to 3, the peripheral device 108 will be explained in more detail. Note that the particular aesthetic design of the user terminal 102 and its GUI shown in FIG. 3 is purely an example for illustrative purposes and does not form part of any subject matter to be claimed herein.

In embodiments the user terminal may take the form of a mobile user terminal such as a smartphone, tablet or laptop, and the peripheral device 108 may take the form of a docking station into which the mobile terminal 102 can be docked in order to form said connection between the peripheral interface 118 of the mobile terminal 102 and the user terminal interface 134 of the peripheral 108. The docking station may also be configured to charge a battery of the mobile terminal 102 when so docked.

An example of this is illustrated in FIGS. 2 to 3. In this example the docking station 108 is also arranged to act as a speaker phone (see above) when the mobile terminal 102 is docked with the docking station 108. FIGS. 2 to 3 show different views of the same example design. As illustrated in FIG. 2, the docking station 108 may comprise a base segment 142 and a cover or top segment 144, movably connected as explained in more detail below so that the cover segment 144 can be opened to reveal the port 134 for connecting to the mobile terminal 108 (e.g. this may comprise a mechanical port such as a USB port, mini USB port or micro USB port). The base segment 142 may be considered a first section, and the cover segment 144 may be considered a second section, and vice versa. Thus when the cover 144 is opened, the mobile terminal 102 can be docked with the docking station in order to provide the various functionality described herein.

In embodiments the speaker (or speakers) 138 may be incorporated in the cover segment 144 while the microphone (or microphones) 140 may be incorporated in the base segment 142.

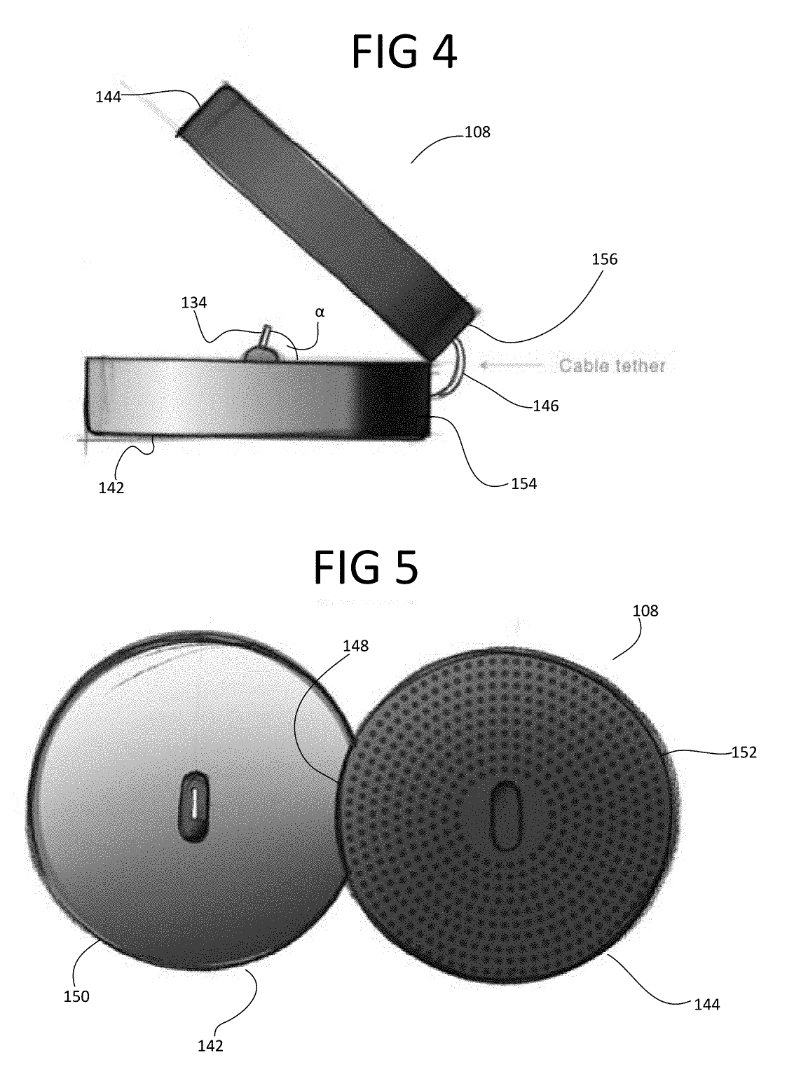

FIG. 4 shows a side view of the peripheral device 108. From this view it can be appreciated that the first or base portion 142 is approximately the same size as the second or top portion 144 (“top” and “base” referencing their orientation in the given FIGs, when the peripheral device is in its closed configuration). Of course, when in its closed configuration the peripheral device can also be held or stood the other way around, such that the “first” portion or section 142 becomes the “top”, and the “second” portion or section 144 becomes the “base”. Therefore, in some embodiments the first and second sections may be considered to each comprise a half of the device i.e. a first and second half respectively. The first and second sections 142 and 144 are connected to each other with a flexible tether 146. The term “tether” can be used interchangeably with terms such as “connector”, “cable” etc. The flexible tether 146 will be explained in more detail further below.

The first and second sections 142 and 144 are arranged in a clamshell fashion or manner. That is the first and second sections are movable (e.g. pivotable or rotatable) relative to each other between a first, closed configuration of the peripheral device, and a second, open configuration of the peripheral device. FIG. 4 shows the peripheral device in an intermediate configuration, between the fully closed and fully open positions. The flexible tether may therefore be considered to act as a hinge to control movement of the first and second sections towards and away from each other, between the fully closed and fully open configurations.

FIG. 5 is a plan view of the peripheral device 108 when in its fully open configuration. The first section 142 is positioned adjacent to the second section 144. It can be appreciated from this FIG that the first and second sections have generally circular outer profiles. Of course in other embodiments outer profiles of other shapes may be provided (e.g. square, rectangular etc.). The outer profile of the peripheral device 108 may also vary across its surface. For example, the outer profile may be coned. In this embodiment the first section 142 comprises a crescent shaped indentation 148 which receives the outer periphery of the generally circular outer periphery of the second section 144. This enables the first and second sections to lie flat next to each other in a space efficient manner, when the device is open. Of course in other embodiments the indentation 148 may be formed in the second section 144, to receive the generally circular outer periphery of the first section 142.

In other embodiments there is no such crescent shaped indentation on either the first section or the second section, both sections having generally circular outer profiles. In such embodiments both the first and second sections tangentially abut each other when the peripheral device is in its open configuration.

In some embodiments one or more magnets or magnetic materials may be provided in the peripheral device 108. For example, a rim 150 (or a portion thereof) of the first section 142, and a rim (or a portion thereof) of the rim 152 of the second section 144 may comprise one or more magnets. The magnet(s) on rim 150 are configured to attract the magnet(s) on rim 152. This helps to ensure that the first and second sections sit correctly relative to each other in a desired fashion when the peripheral device 108 is in a closed configuration, for example so that the rim 150 of the first section is contiguous with the rim 152 of the second section. This also helps ensure that the peripheral device 108 remains closed when necessary, for example during transport.

One or more magnets may additionally be provided on a side (or a portion of the side) of the first and second sections 142 and 144. For example, a magnet may be positioned on side 154 of first section 142, and a corresponding magnet may be provided on a side 156 of second section 144. These magnets are configured to attract each other, such that when in the open configuration of the peripheral device 108 the two sections of the peripheral device are attracted to each other. These magnets may also, in conjunction with the flexible tether 146, act to guide the first and second sections to a correct configuration when open (e.g. a configuration as shown in FIG. 2) where the first section 142 abuts the second section 144, so that the tether 146 is fully enclosed within the first and sections when the peripheral device is open.

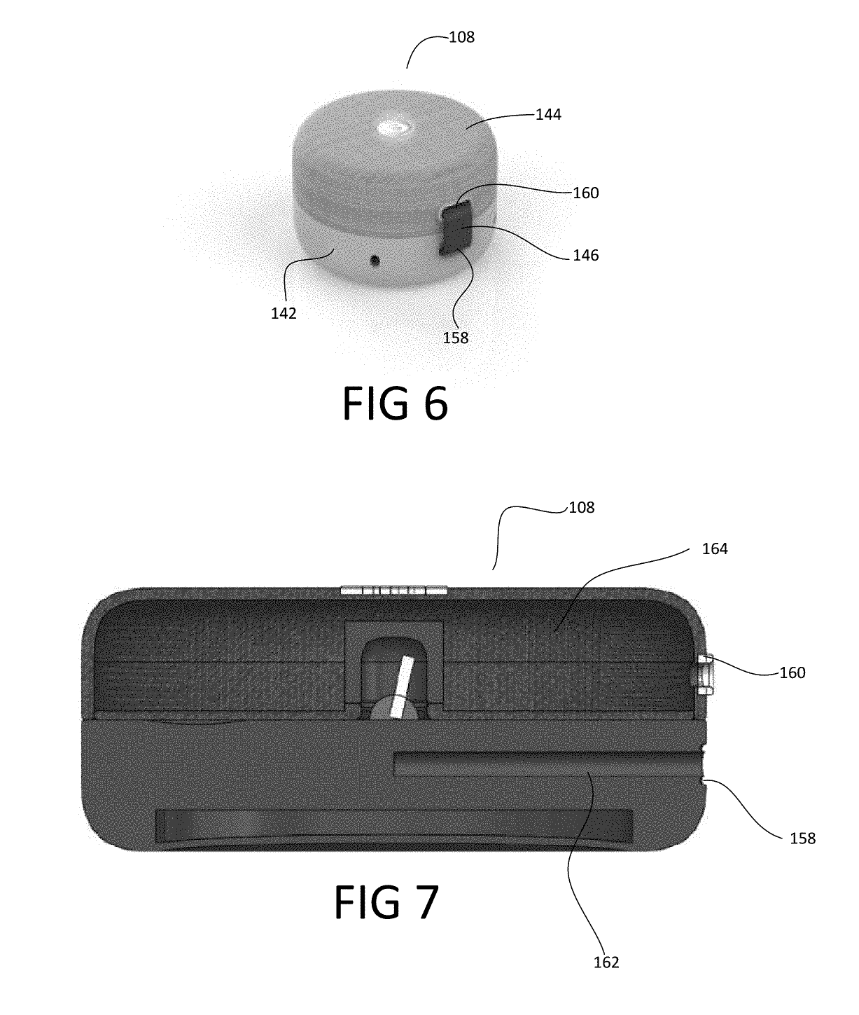

FIG. 6 is an isometric view showing the peripheral 108 in its closed configuration. As shown in this FIG the first section 142 comprises an aperture 158 for receiving the tether 146 in the first section 142. The second section 144 comprises an aperture 160 for receiving the tether 146 in the second section 144. The apertures 158 and 160 are each shaped to conform to an outer profile of the tether 146. The aperture 158 is located approximately mid-way down a side surface of first section 142. The aperture 160 is located approximately mid-way down a side surface of second section 144.

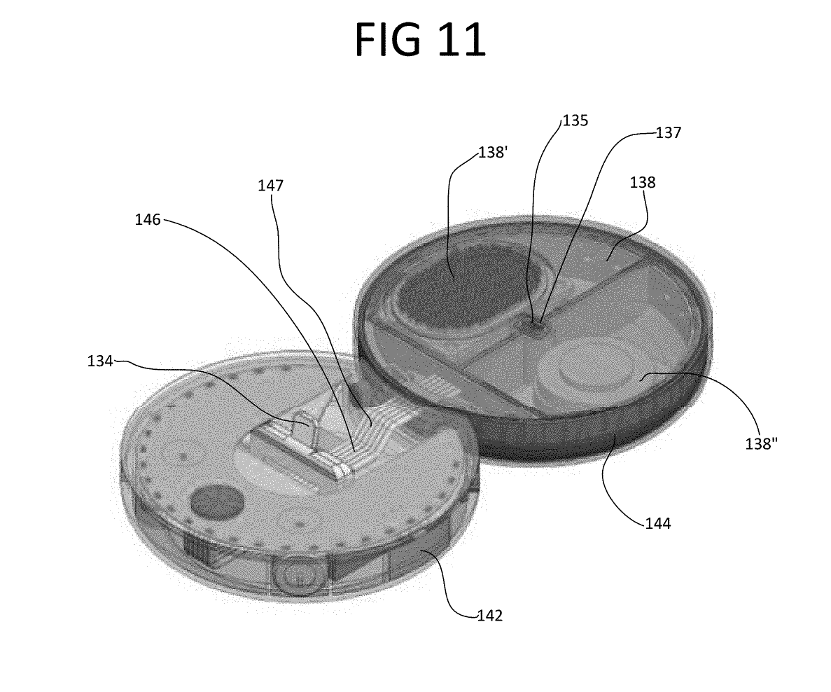

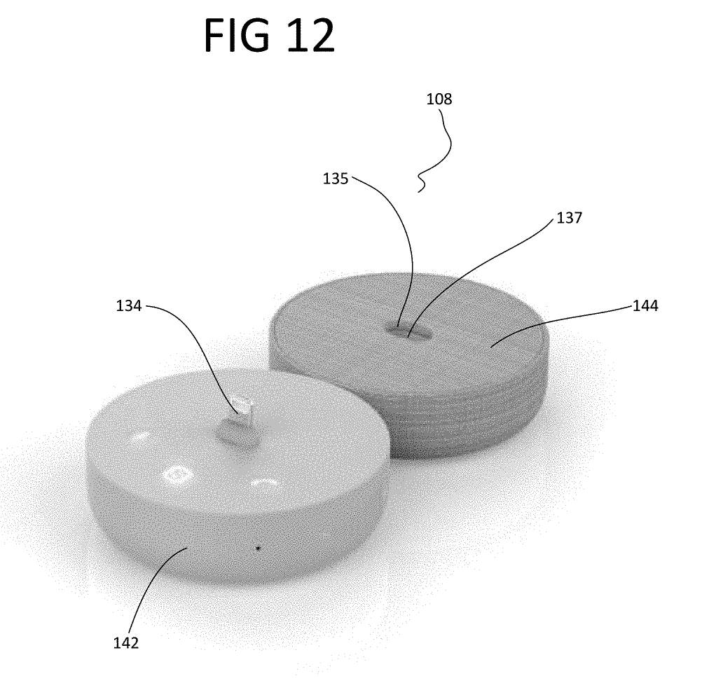

FIG. 12 shows the peripheral device 108 in its open state. Note that in this embodiment the two sections 142 and 144 both have generally circular outer peripheries around their entire perimeters. Also of note are interface 134 which projects from first section 142 at an angle, and corresponding aperture 135 and cavity 137 for receiving the interface 134 in the second section 144 when the peripheral device is closed. This is discussed in more detail with respect to FIG. 11.

In some embodiments the tether 146 comprises an electrical cable. As shown in the FIGs the cable 146 is in the form of a flat or ribbon type of electrical cable. In the embodiment shown in FIG. 6 the first section 142 does not comprise an indentation for receiving the circular periphery of the second section 144, in contrast with the embodiment of FIG. 2. Therefore, the flexible tether 146, acting as an electrical cable, can electrically connect the first section 142 to the second section 144. In embodiments the user terminal interface 134 is electrically connected to the flexible tether 146, so that electrical signals can be passed from the user terminal to the peripheral device 108 via the interface 134 and flexible tether 146. In some embodiments the interface 134 and/or flexible tether 146 comprises a lightning cable.

FIG. 7 shows a side view of the peripheral device 108 in cross section, when in a closed configuration. This FIG shows the first and second apertures 158 and 160. The aperture 158 provides an opening for the tether 146 into an interior 162 of the first section 142. The aperture 160 provides an opening for the flexible together 146 into an interior 164 of the second section 144.

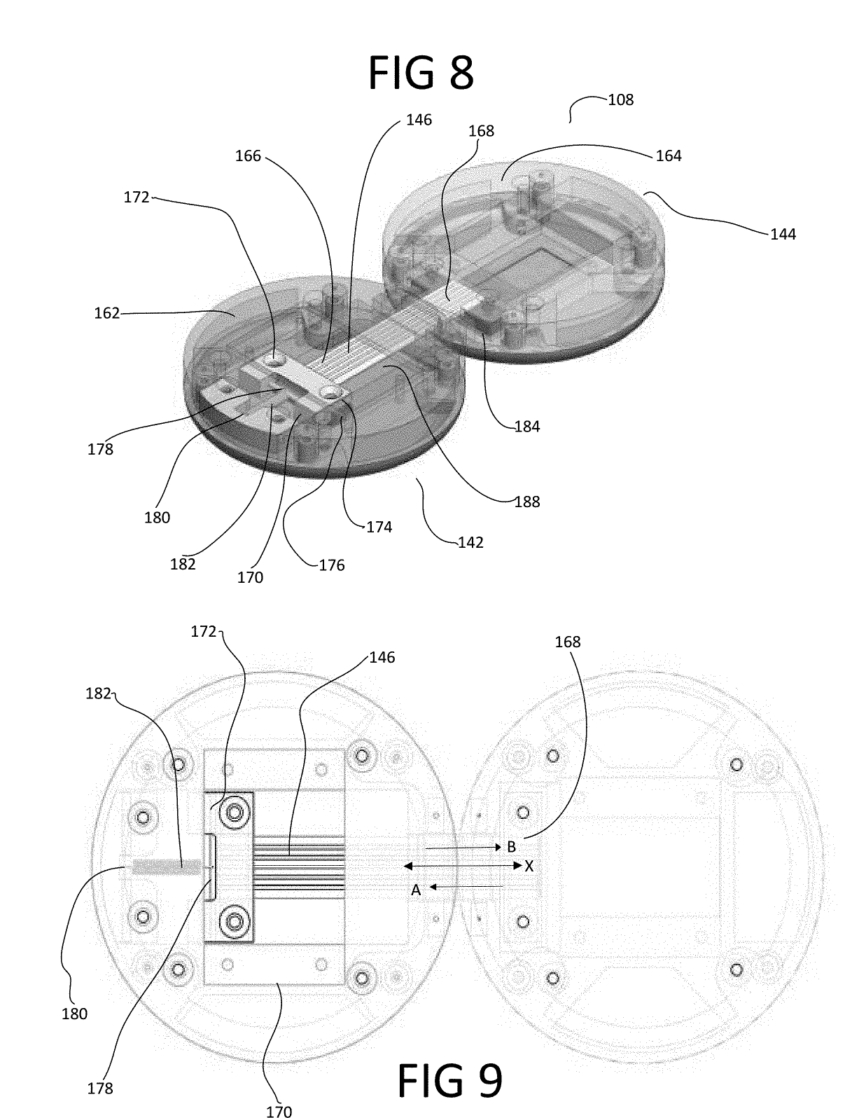

FIG. 8 is an isometric view of the peripheral device 108 in its open configuration. In FIG. 8 certain parts are shown in phantom so that a biasing and clamping arrangement for clamping and biasing the flexible tether 146 can be seen.

The flexible tether 146 comprises a first end 166 which is connected to the first section 142 in the interior 162 of the first section 142. The tether 146 also comprises a second end 168 which is connected to the second section 144 in the interior 164 of the second section 144. The peripheral device 108 comprises a biasing and clamping arrangement shown generally at 170. In this example the biasing and clamping arrangement 170 is located in the first section 142. It will of course be understood that the biasing and clamping arrangement could alternatively be located in the second section 144. In a further embodiment both sections 142 and 144 may comprise a biasing and clamping arrangement of the type shown.

The arrangement 170 comprises a clamping arrangement 172 which clamps the tether 146. In the embodiment shown the clamping arrangement comprises a first clamping part or first plate 174 and a second clamping part or second plate 176, between which the tether 146 is clamped. The first and second plates may be connected by any means, for example by screws or adhesive. The clamping arrangement 172 further comprises an anchor 178. A further anchor 180 is provided in the interior 162 of the peripheral device 108.

A biasing means 182 is fixed to anchor 178 at a first end of the biasing means, and to anchor 180 at a second end of the biasing means 182. In this embodiment the biasing means comprises a helical spring. In this embodiment the helical spring 182 is attached to anchor points 178 and 180 by a hook at each end of the helical spring. Of course any other connection means may be used in other examples. Therefore, the flexible tether 146 may be considered to be spring-loaded, for example via the clamping arrangement 172.

The second end 168 of the tether 146 is clamped to the second section 144 between a first plate 184 and a second plate (second plate not shown in FIG. 8 for clarity). In the embodiment of FIG. 8 the second section 144 does not comprise a biasing arrangement for biasing the tether in the second section 144.

The first section 142 comprises a channel portion 188 in which the clamping arrangement 172 can translate, or slide, back and forth as shown by bi-directional of arrow X (see FIG. 9). That is when viewing FIG. 9 the clamping arrangement can slide from left to right and from right to left.

The biasing means or mechanism acts to maintain a tension force within the flexible tether 146 at all times. For example, the biasing mechanism causes there to be tension within the flexible together 146 whether the peripheral device is in its fully closed configuration, its fully open configuration, or any position in between. The components of the peripheral device (e.g. length of tether; position of clamping arrangements within the first and second sections; positioning of, strength and length of spring 182 etc.) are selected so as to provide this function.

Viewing FIG. 9, when the peripheral device is at rest in its open configuration the tether is being pulled in the direction of Arrow A by the spring 182. This creates a tension force in the tether 146 which, due to the clamping of the tether 146 within second section 144, also causes the second section 144 to be drawn towards the first section 142. This acts to create a connection between the first and second sections such that a deliberate force is required to pull them apart, thus leading to a peripheral device which provides a stable base for a user terminal mounted thereon. To this end the tether 146 may be considered a retractable connector. More specifically the tether 146 may be considered a spring loaded retractable connector. By way of example only and for the purposes of comparison, if the flexible tether were to be considerably longer than strictly necessary and there was no biasing arrangement then the two sections would not be drawn towards each other and would be able to move freely relative to each other, which would not provide as stable a base for a user terminal mounted thereon.

When the peripheral device 108 is moved between its fully open configuration towards its fully closed configuration by an external force (e.g. a user closing the device with their hands) the tether 146 is caused to move in a direction out of the first section 142. That is the flexible tether 146 is pulled in the direction of Arrow B when viewing FIG. 9. The spring 182 tries to counteract this force by providing a tension force acting in the opposite direction (i.e. acting in direction A when viewing FIG. 9). The spring 182 is chosen to have a spring force (or spring rate) such that its force can be relatively easily overcome by a user closing the peripheral device, but which spring force is sufficiently high such that it can maintain tension in the tether 146. Therefore, when the peripheral device is in its closed configuration (see for example FIG. 6) the tether 146 remains in tension. Not only does this help to hold the first and second sections 142 and 144 in their closed configuration, it also keeps the tether 146 tight against the side of the peripheral device 108 giving a neat and compact overall profile and reduces the chance of snagging. For example, the tether 146 is more compact than a traditional, hard clamshell hinge.

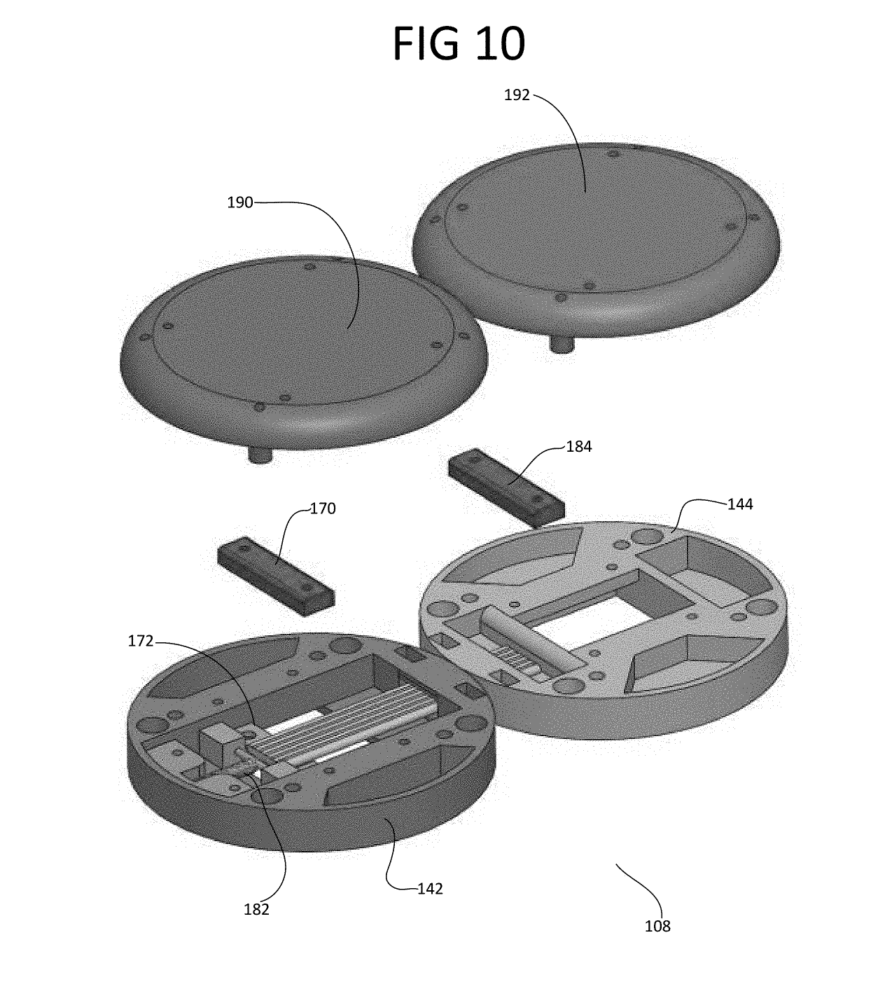

FIG. 10 is an exploded isometric view of some components of the peripheral device 108, viewed from the opposite side from FIG. 8. That is FIG. 8 may be considered to be looking at the peripheral device from the top when in its open configuration, whereas FIG. 10 may be considered to be looking at the peripheral device from its underside when in its open configuration. Therefore, more clearly shown in FIG. 10 are caps or covers 190 and 192. Cover 190 is configured to be attached to first section 142. Cover 192 is configured to be attached to second section 144. When the device is in its open configuration the covers 190 and 192 form a base surface of the device. The covers 190 and 192 may be made from any material. In some embodiments the covers 190 and 192 are formed from plastic. In some embodiments one or more of the caps may also be coated in another material, such as a fabric.

In some embodiments the flexible tether may define a generally straight or horizontal profile when the peripheral device is in its open configuration (see for example FIGS. 8 to 10). The flexible tether, or at least a portion thereof, may define a generally U-shaped profile when the peripheral device is in its closed configuration (see for example FIG. 6).

It will of course be understood that the tethering and biasing mechanisms described herein are by way of example only and that modifications may be made in other embodiments. For example, the biasing mechanism need not include a helical spring. In some embodiments the spring may be another type of spring, such as a leaf spring. In some embodiments the biasing may be provided by a resilient material, such as rubber or foam. In some embodiments the biasing may be provided by the flexible tether itself. For example, the flexible tether may comprise an elastic material.

It can be appreciated from FIG. 10, and also for example from FIGS. 2, 8, 11 and 12, that when the device is in its fully open configuration the first and second sections 142 and 144 provide a generally flat bottom surface for mounting on a generally flat surface such as a table. In some embodiments, when in its open, flat configuration the two sections 142 and 144 of the peripheral device touch each other in a tangential manner.

FIG. 11 shows an embodiment which is a slight alternative to that of FIG. 10. In this embodiment the tether arrangement is such that when the device is in its fully open configuration (such as shown in FIG. 11) the tether is not completely straight or horizontal i.e. there is a step or ramped portion 147 between the first and second ends of the tether. Also visible in FIG. 11 is speaker unit 138. Speaker unit 138 comprises a first speaker 138′ and a second speaker 138″. These speakers may be powered by virtue of electrical connection to flexible electrical tether 146.

Also visible in FIG. 11 is projection 134 for connecting the peripheral device to a user terminal, as explained above with reference to FIGS. 2 and 3. In some embodiments the projection 134 projects from the first section 142 at an angle α (see FIG. 4). In embodiments α is less than 90 degrees so that the user terminal is tilted when docked thereon. Preferably α is between about 45 degrees and about 85 degrees. This provides an optimum viewing angle for a user.

An aperture 135 is comprised in the second section 144. The aperture 135 is configured to correspond with projection 134, so that when the device is in its closed configuration the projection 134 is contained within and is substantially enclosed by cavity 137 extending into the second section 144 from aperture 135. The cavity 137 is disposed in the second section 144 at an angle which corresponds with or equals the angle α at which the projection 134 projects from the first section 142. This provides a compact overall arrangement and also provides protection for the projection 134 when the peripheral device is in its closed configuration.

The combination of the flexible tether which holds the first and second sections together, and the angle α at which the projection 134 projects (which controls an angle at which a user terminal is mounted thereon, and consequently a turning moment on the peripheral device caused by the tilted user terminal) ensures that the user terminal is stably held on the peripheral device 108 when mounted thereon.

In embodiments the projecting interface 134 is electrically connected to the flexible tether 146, which tether 146 comprises an electrical cable in at least some embodiments. Therefore, electrical signals can be transmitted from the user terminal through the peripheral device via the interface 134 and tether 146, for example to send signals to speaker apparatus 138.

It will be appreciated that the above embodiments have been described only by way of example. Other variants may become apparent to a person skilled in the art once given the disclosure herein. The scope of the present disclosure is not limited by the described embodiments but only by the accompanying claims.

1. A peripheral device for use with a user terminal, the peripheral device comprising:
a first section; and
a second section;
the first and second sections being arranged relative to each other in a clamshell manner, and the first and second sections being movable relative to each other between a first, closed configuration of the peripheral device, and a second, open configuration of the peripheral device;
the peripheral device comprising a flexible tether portion connecting the first section to the second section;
the flexible tether portion being biased so as to maintain a tension in the tether.

2. A peripheral device as set forth in claim 1, wherein the flexible tether is biased by a biasing arrangement located in one or both of the first section and the second section.

3. A peripheral device as set forth in claim 2, wherein the biasing arrangement comprises a clamping arrangement which clamps the tether.

4. A peripheral device as set forth in claim 3, wherein the clamping arrangement comprises first and second plates which clamp the tether therebetween.

5. A peripheral device as set forth in claim 3, the clamping arrangement being configured to translate back and forth in response to the peripheral device being moved between its first and second configurations.

6. A peripheral device as set forth in claim 3, the clamping arrangement having a first position when the peripheral device is in its first, closed configuration, and the clamping arrangement having a second position when the peripheral device is in its second, open configuration.

7. A peripheral device as set forth in claim 6, the clamping arrangement configured to move with a biasing force of the biasing arrangement when the clamping arrangement is moved from the first position to the second position.

8. A peripheral device as set forth in claim 6, the clamping arrangement configured to move against a biasing force of the biasing arrangement when the clamping arrangement is moved from the second position to the first position.

9. A peripheral device as set forth in claim 2, wherein the biasing arrangement is comprised in the first section, and wherein the biasing arrangement is configured to allow the flexible tether to be drawn in a direction in to the first section when the peripheral device is moved from its closed configuration to its open configuration, and wherein the biasing arrangement is configured to allow the flexible tether to be drawn in a direction out of the first section when the peripheral device is moved from its open configuration to its closed configuration.

11. A peripheral device as set forth in claim 1, wherein the tether comprises a flat electrical cable, configured for electrically connecting the first and second sections.

12. A peripheral device as set forth in claim 1, wherein when the peripheral device is in its open configuration the tether assumes a generally straight profile, and wherein when the peripheral device is in its closed configuration at least a portion of the tether assumes a generally U-shaped profile.

13. A peripheral device as set forth in claim 1, wherein the first and second sections each have a generally circular outer periphery, and wherein one of the first and second sections has a crescent shaped indentation therein, the crescent shaped indentation configured to receive the generally circular outer periphery of the other of the first and second sections when the peripheral device is in its open configuration.

14. A peripheral device as set forth in claim 1, comprising an interface projecting from one or other of the first and second sections for communicatively connecting to a user terminal.

15. A peripheral device as set forth in claim 16, comprising a cavity located in the other of the first and second sections, wherein the cavity is configured to receive the interface when the peripheral device is in its closed configuration.

16. A peripheral device as set forth in claim 17, wherein the interface projects at an angle from a surface of the first or second section, the cavity extending in to the other of the first or second surface at the same angle.

17. A peripheral device as set forth in claim 16, the interface being connected to the flexible tether for electrical communication therewith.

18. A peripheral device as set forth in claim 16, comprising control logic for interfacing with the user terminal via said interface, in order to control a communication client application running on the user terminal, and to thereby control a voice or video call that is conducted over a packet-based network from the user terminal using the communication client application.

19. A peripheral device comprising:
a first section;
a second section;
the first and second sections being arranged relative to each other in a clamshell manner, and the first and second sections being movable relative to each other between a first, closed configuration of the peripheral device, and a second, open configuration of the peripheral device, the peripheral device comprising a flexible tether portion connecting the first section to the second section, the flexible tether portion being biased so as to maintain a tension in the tether;
an interface projecting from one or other of the first and second sections for communicatively connecting to a user terminal; and
control logic for interfacing with the user terminal via said interface, in order to control a communication client application running on the user terminal, and to thereby control a voice or video call that is conducted over a packet-based network from the user terminal using the communication client application.

20. A peripheral device comprising:
a first section; and
a second section;
the first and second sections being arranged relative to each other in a clamshell manner, and the first and second sections being movable relative to each other between a first, closed configuration of the peripheral device, and a second, open configuration of the peripheral device, the peripheral device comprising a flexible tether portion connecting the first section to the second section, the flexible tether portion being biased by a biasing arrangement located in one or both of the first section and the second section so as to maintain a tension in the tether.
